(19) United States
(12) Patent Application Publication
(10) Pub. No.: US 2026/0077506 A1
(43) Pub. Date: Mar. 19, 2026

(54) TASK SELECTION FOR A HAND-HELD MANIPULATION DEVICE

(71) Applicant: Toyota Research Institute, Inc., Los Altos, CA (US)

(72) Inventors: Blake Wulfe, San Francisco, CA (US); Yuki Noguchi, Los Altos, CA (US); Mikhal Itkina, Los Altos, CA (US); Benjamin Burchfiel, Los Altos, CA (US); Siyuan Feng, Los Altos, CA (US); Patrick Miller, Los Altos, CA (US); Tony Nguyen, Los Altos, CA (US); Derick Seale, Los Altos, CA (US); Donovon Jackson, Los Altos, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 19/181,885

(22) Filed: Apr. 17, 2025

Related U.S. Application Data
(60) Provisional application No. 63/694,483, filed on Sep. 13, 2024.

(51) Int. Cl. B25J 9/16

(52) U.S. Cl. CPC B25J 9/1697

(57) ABSTRACT

A method includes receiving an image of a scene, receiving a request to identify tasks that may be performed by a user utilizing a hand-held manipulation device, based on the image of the scene, in response to receiving the request to identify the tasks that may be performed by the user utilizing the hand-held manipulation device, analyzing the image of the scene to determine one or more suggested tasks that may be performed by the user utilizing the hand-held manipulation device, outputting the one or more suggested tasks that may be performed by the user utilizing the hand-held manipulation device, and receiving training data in response to outputting the one or more suggested tasks that may be performed by the user utilizing the hand-held manipulation device.

### CROSS-REFERENCE TO RELATED APPLICATION

The present specification is based on, and claims the benefit of U.S. Provisional Application No. 63/694,483, filed Sep. 13, 2024, the disclosure of which is hereby incorporated by reference in its entirety.

### TECHNICAL FIELD

The present specification relates to robotic object manipulation, and more particularly to task selection for a hand-held manipulation device.

### BACKGROUND

One way to train robots to perform physical manipulation tasks is to record video or images of humans performing the task, and then train a robot to perform the same task through imitation learning. In particular, a human may utilize a hand-held gripper to perform a task while a camera records video of the human performing the task with the hand-held gripper. A large number of trials of humans performing the task using the hand-held gripper may be recorded with the camera. This collection of trials may then be used as training data to train a robotic arm, having similar grippers as the hand-held gripper, to perform the task through imitation learning by mimicking the behavior of the hand-held gripper controlled by humans in the training data.

As such, a human user can perform a variety of different tasks while using the hand-held gripper to collect training data. However, it may be difficult for the user to identify appropriate tasks to perform. Accordingly, there is a need for an improved method of task selection for a hand-held manipulation device.

### SUMMARY

In one embodiment, a method includes receiving an image of a scene, receiving a request to identify tasks that may be performed by a user utilizing a hand-held manipulation device, based on the image of the scene, in response to receiving the request to identify the tasks that may be performed by the user utilizing the hand-held manipulation device, analyzing the image of the scene to determine one or more suggested tasks that may be performed by the user utilizing the hand-held manipulation device, outputting the one or more suggested tasks that may be performed by the user utilizing the hand-held manipulation device, and receiving training data in response to outputting the one or more suggested tasks that may be performed by the user utilizing the hand-held manipulation device.

In another embodiment, a computing device includes one or more processors configured to receive an image of a scene, receive a request to identify tasks that may be performed by a user utilizing a hand-held manipulation device, based on the image of the scene, in response to receiving the request to identify the tasks that may be performed by the user utilizing the hand-held manipulation device, analyze the image of the scene to determine one or more suggested tasks that may be performed by the user utilizing the hand-held manipulation device, output the one or more suggested tasks that may be performed by the user utilizing the hand-held manipulation device, and receive training data in response to outputting the one or more suggested tasks that may be performed by the user utilizing the hand-held manipulation device.

In another embodiment, a non-transitory computer readable storage medium includes a memory storing a program. When executed by a processor, the program may cause the processor to receive an image of a scene, receive a request to identify tasks that may be performed by a user utilizing a hand-held manipulation device, based on the image of the scene, in response to receiving the request to identify the tasks that may be performed by the user utilizing the hand-held manipulation device, analyze the image of the scene to determine one or more suggested tasks that may be performed by the user utilizing the hand-held manipulation device, output the one or more suggested tasks that may be performed by the user utilizing the hand-held manipulation device, and receive training data in response to outputting the one or more suggested tasks that may be performed by the user utilizing the hand-held manipulation device.

### BRIEF DESCRIPTION OF THE DRAWINGS

The embodiments set forth in the drawings are illustrative and exemplary in nature and are not intended to limit the disclosure. The following detailed description of the illustrative embodiments can be understood when read in conjunction with the following drawings, where like structure is indicated with like reference numerals and in which:

FIG. 1A depicts a hand-held manipulation device, according to one or more embodiments shown and described herein;

FIG. 1B depicts another view of the hand-held manipulation device of FIG. 1A, according to one or more embodiments shown and described herein;

FIG. 2 depicts an example robot, according to one or more embodiments shown and described herein;

FIG. 3 depicts an example computing device, according to one or more embodiments shown and describe herein;

FIG. 4 depicts example memory modules of the computing device of FIG. 3, according to one or more embodiments shown and described herein;

FIG. 5 depicts a user utilizing two hand-held manipulation devices of FIGS. 1A and 1B to perform a task, according to one or more embodiments shown and described herein; and

FIG. 6 depicts a flowchart of a method of operating the computing device of FIG. 3.

### DETAILED DESCRIPTION

The embodiments disclosed herein include task selection for a hand-held manipulation device. In embodiments, a hand-held manipulation device may include grippers with a variety of sensors therein. The hand-held manipulation device may also include a camera that can capture images and/or video of the grippers. As such, when a user holds the hand-held manipulation device and performs a physical manipulation task with the grippers, the camera may capture images and/or video of the grippers performing the task.

Furthermore, before the user performs a task with the hand-held manipulation device, the camera may capture an image of the environment surrounding the user. The environment may include a variety of objects that can be interacted with. This image may then be input into a vision language model (VLM) along with a prompt asking for tasks that may be performed in the environment. The VLM may then output tasks that can be performed in the environment based on the input image and the input prompt. The user may then perform those tasks to generate training data.

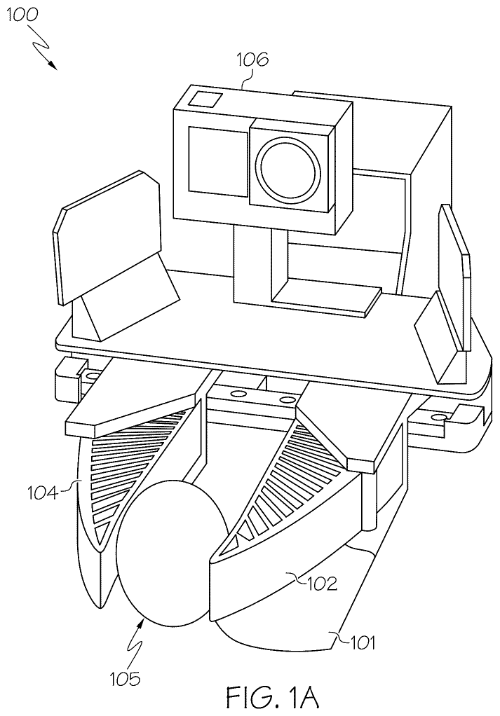

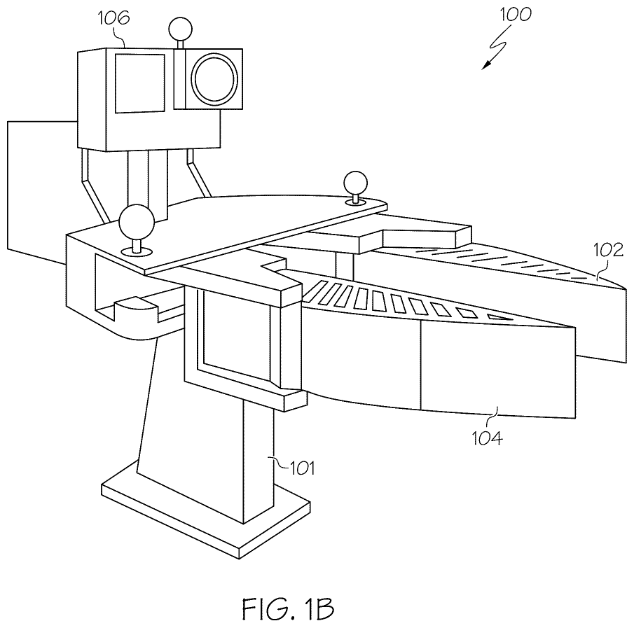

FIGS. 1A and 1B depict an example hand-held manipulation device 100 from two different perspectives. The device 100 may include a handle 101 that may be gripped by a user. The device 100 includes grippers 102 and 104, which may be used to grip objects. In particular, the grippers 102, 104 may have a finger-like shape to pick up and manipulate objects. The handle 101 may include a trigger or other mechanism to close the grippers 102, 104. This may allow a user to grasp and manipulate objects with the grippers 102, 104. In the example of FIG. 1A, the grippers 102, 104 are holding an egg 105.

In the illustrated example, the grippers 102 and 104 may be made of a compliant material, such as an elastomer. This may allow for manipulation of objects by the grippers 102, 104 without damaging the objects. In some examples, the grippers 102, 104 may contain one or more sensors (e.g., tactile sensors, vibration sensors, acoustic sensors, and the like). These sensors may gather sensor data about objects being manipulated by the grippers 102, 104.

The hand-held manipulation device 100 may also include a computing device 106 including a camera. The computing device 106 may be affixed to the device 100 such that the grippers 102, 104 are within the field of view of a lens of a camera. Accordingly, the camera of the computing device 106 may capture images and/or video of the grippers 102, 104 while the user performs tasks with the device 100. As such, the computing device 106 may collect training data that may be used to train a robot to perform the task. The computing device 106 is described in further detail below. In some examples, the device 100 may comprise a camera that is separate from the computing device 106,

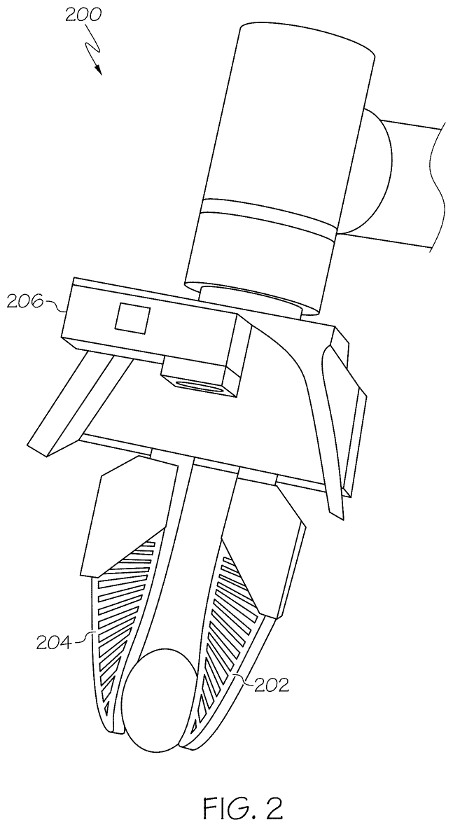

FIG. 2 depicts an example robot 200 that may be trained to perform a task based on training data collected by the device 100. In the example of FIG. 2, the robot 200 comprises grippers 202, 204 similar to the grippers 102, 104 of FIGS. 1A and 1B. The robot 200 may also comprise a computing device 206 having a camera similar to the computing device 106 of FIGS. 1A and 1B. In operation, the robot 200 may be trained to perform tasks based on training data collected by the device 100. After the robot 200 is trained, the robot may perform specified tasks according to the training using the grippers 202, 204 and the camera of the computing device 206. In particular, the camera of the computing device 206 may capture images of a scene and various motors of the robot 200 may control operation of the grippers 202 204 to perform a specified task.

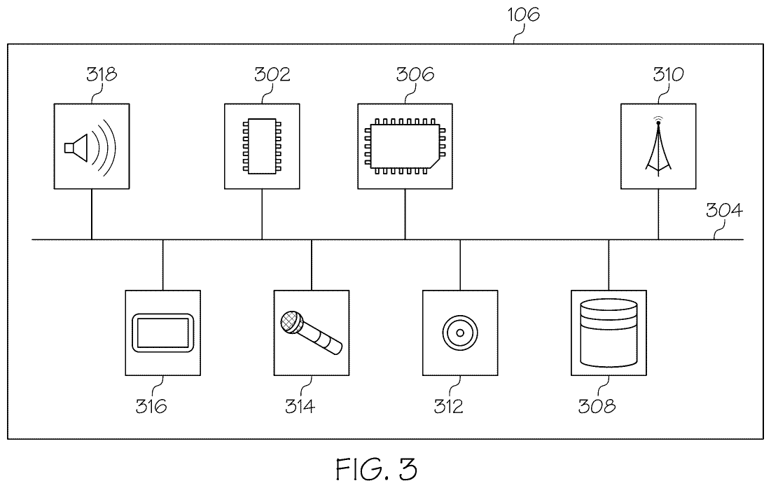

FIG. 3 schematically depicts the computing device 106 of FIGS. 1A and 1B. The computing device 106 may perform the operations of the embodiments disclosed herein. In the illustrated example, the computing device 106 includes one or more processors 302, a communication path 304, one or more memory modules 306, a data storage component 308, network interface hardware 310, a camera 312, a microphone 314, a screen 316, and a speaker 318, the details of which will be set forth in the following paragraphs.

Each of the one or more processors 302 may be any device capable of executing machine readable and executable instructions. Accordingly, each of the one or more processors 302 may be a controller, an integrated circuit, a microchip, a computer, or any other physical or cloud-based computing device. The one or more processors 302 are coupled to a communication path 304 that provides signal interconnectivity between various modules of the computing device 106. Accordingly, the communication path 304 may communicatively couple any number of processors 302 with one another, and allow the modules coupled to the communication path 304 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 304 may be formed from any medium that is capable of transmitting a signal such as, for example, conductive wires, conductive traces, optical waveguides, or the like. In some embodiments, the communication path 304 may facilitate the transmission of wireless signals, such as WiFi, Bluetooth®, Near Field Communication (NFC) and the like. Moreover, the communication path 304 may be formed from a combination of mediums capable of transmitting signals. In one embodiment, the communication path 304 comprises a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

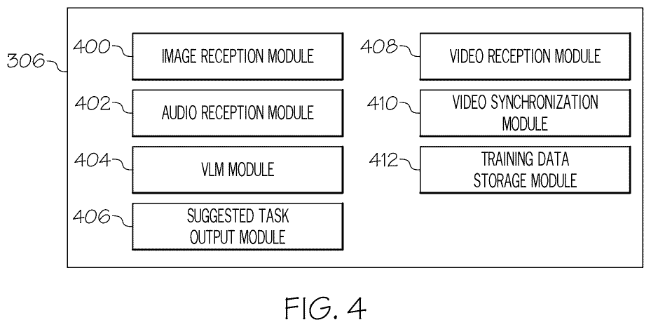

The computing device 106 includes one or more memory modules 306 coupled to the communication path 304. The one or more memory modules 306 may comprise RAM, ROM, flash memories, hard drives, or any device capable of storing machine readable and executable instructions such that the machine readable and executable instructions can be accessed by the one or more processors 302. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 306. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The memory modules 306 are discussed in more detail below in connection with FIG. 4.

Referring still to FIG. 3, the example computing device 106 includes a data storage component 308. The data storage component 308 may store data used by the computing device 106. The data storage component 308 may also store other data used by the various components of the computing device 106. The data storage component 308 may also store image data captured by the computing device 106, as disclosed in further detail below.

Still referring to FIG. 3, the computing device 106 comprises network interface hardware 310 for communicatively coupling the computing device 106 to the external computing devices. As such, the network interface hardware 310 may send data to and/or receive data from various external computing devices. The network interface hardware 310 may comprise a wired and/or wireless connection to one or more external computing devices. In other examples, the network interface hardware 310 may be send data to and/or receive data from other computing devices.

The network interface hardware 310 can be communicatively coupled to the communication path 304 and can be any device capable of transmitting and/or receiving data via a network. Accordingly, the network interface hardware 310 can include a communication transceiver for sending and/or receiving any wired or wireless communication. For example, the network interface hardware 310 may include an antenna, a modem, LAN port, Wi-Fi card, WiMax card, mobile communications hardware, near-field communication hardware, satellite communication hardware and/or any wired or wireless hardware for communicating with external computing devices.

Referring still to FIG. 3, the computing device 106 comprises a camera 312. As discussed above, the camera 312 may capture images and/or video of tasks performed by the grippers 102, 104 of the device 100. In particular, the field of view of the camera 312 may include the grippers 102, 104 such that movements and operations of the grippers 102, 104 may be captured by the camera 312. While the example of FIG. 3 shows the computing device 106 including the camera 312, in some examples, the camera 312 may be a separate device from the computing device 106. In these examples, the camera 312 may transmit captured images to the computing device 106.

Referring still to FIG. 3, the computing device 106 comprises a microphone 314. The microphone 314 may capture audio, such as words spoken by a user. In particular, before a user utilizes the grippers 102, 104 to perform a task, the user may verbally speak the name of the task that they are about to perform. This statement may be recorded by the microphone 314 and used to appropriately classify the training images associated with the task, as discussed in further detail below.

Referring still to FIG. 3, the computing device 106 comprises a screen 316. The screen 316 may display visual information output by the computing device 106, as disclosed in further detail below. The computing device 106 also comprises a speaker 318. The speaker 318 may output audio information output by the computing device 106, as disclosed in further detail below.

Referring now to FIG. 4, the one or more memory modules 306 of the computing device 106 include an image reception module 400, an audio reception module 402, a VLM module 404, a suggested task output module 406, a video reception module 408, a video synchronization module 410, and a training data storage module 412. Each of the image reception module 400, the audio reception module 402, the VLM module 404, the suggested task output module 406, the video reception module 408, the video synchronization module 410, and the training data storage module 412 may be a program module in the form of operating systems, application program modules, and other program modules stored in the one or more memory modules 306. Such a program module may include, but is not limited to, routines, subroutines, programs, objects, components, data structures and the like for performing specific tasks or executing specific data types as will be described below.

The image reception module 400 may receive an image of a scene captured by the camera 312. As discussed above, a user may perform tasks with the device 100 while the camera 312 records video of the tasks being performed. The recorded video may be used as training data to train a robot, such as the robot 200 of FIG. 2, via imitation learning to perform the tasks by mimicking actions performed with the device 100 by the user. In some examples, the user may hold two devices 100, one in each hand, to perform tasks.

Different tasks can be performed in different environments. For example, a user may perform tasks such as moving objects, folding clothes, washing dishes, and the like, depending on the types of objects present in the scene. In some examples, a user may perform a variety of different tasks sequentially, thereby allowing for the collection of more training data. However, the user may not always be able to think of appropriate tasks to perform in a particular environment, thereby limiting the amount of training data that can be collected. Accordingly, in embodiments disclosed herein, an image of the environment may be captured with a camera, and a VLM may be used to suggest tasks that may be performed by the user in the environment, as discussed in further detail below. The user may then perform the suggested tasks to generate training data.

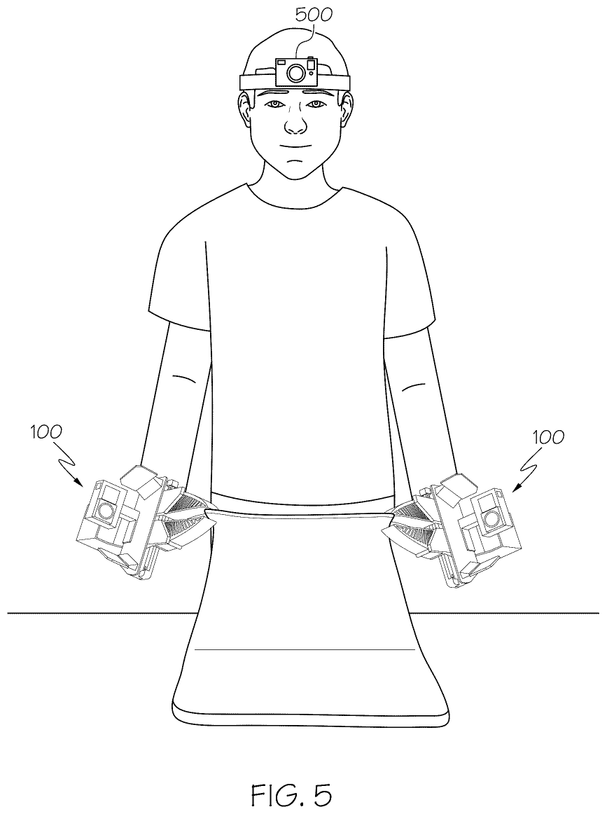

In embodiments, the image reception module 400 may receive an image of a scene of the environment in which the user is located. In some examples, the user may capture an image of the environment using the camera 312 of the device 100. For example, the user may position the device 100 such that the environment is within a field of view of the camera 312, and may press a button, speak a particular word or phrase, or otherwise activate the camera 312 to capture an image of the environment. In some examples, the user may wear a head-mounted camera in addition to holding two of the devices 100, as shown in the example of FIG. 5. In the example of FIG. 5, a user holds two devices 100, one in each hand, and wears a head-mounted camera 500. The head-mounted camera 500 may capture images and/or video, which may be transmitted to the computing device 106. As such, in embodiments, the image reception module 400 may receive an image of a scene captured by the camera 312 of the device 100, the head-mounted camera 500, or from another camera. In operation, the user may capture an image of their environment before beginning to perform tasks. The image received by the image reception module 400 may be used to suggest tasks that may be performed by the user, as disclosed in further detail below.

Referring back to FIG. 4, the audio reception module 402 may receive audio captured by the microphone 314 of the device 100. Before a user performs a particular task with the one or two devices 100, the user may speak the name of the task that they are about to perform (e.g., “folding clothes”). The microphone 314 may detect this audio, and the detected audio may be received by the audio reception module 402. The user may then perform the task. The audio indicating the task to be performed may be stored along with the video of the task being performed as training data, as discussed in further detail below. As such, the audio indicating the task to be performed may be used as a label during training of the robot. In some examples, the user may also speak a command such as “start task” to indicate the start of the task being performed and a command such as “stop task” to indicate the end of the task being performed. These commands may also be received by the audio reception module 402.

Referring still to FIG. 4, the VLM module 404 may implement a vision language model, as disclosed herein. A VLM is a machine learning model that may receive an image and a text prompt associated with the image, as input, and may output a response to the text prompt based on the image. In particular, the text prompt may be a question about the image, and the output may answer the question. VLMs may be jointly trained on images and text, such that a trained VLM can answer questions about an input image.

In embodiments, the VLM module 404 may input the image received by the image reception module 400 of a scene, along with a prompt asking for tasks that can be performed, into a trained VLM. For example, the VLM module 404 may input a prompt of “what tasks can be performed in this scene?”, or a similar prompt to cause the VLM to output tasks that may be performed by the user in the scene. In embodiments, the VLM module 404 may automatically generate the appropriate prompt to input to the VLM. In response to receiving the image and the prompt, the VLM may output one or more suggested tasks that may be performed by the user utilizing the device 100 based on the image.

In some examples, the VLM module 404 may specify preferences for different tasks, such as tasks involving particular light conditions, specified duration, or use of particular components. In some examples, the user may specify these preferences. This may allow the user to specify the types of tasks they would like to perform. In these examples, the VLM module 404 may modify the prompt input to the VLM to indicate that the selected tasks should conform to the specified preferences. In some examples, the VLM used by the VLM module 404 may be fine-tuned to select certain types of tasks that are preferably used to train the robot 200.

Referring still to FIG. 4, the suggested task output module 406 may output the suggested tasks determined by the VLM module 404. As discussed above, the VLM module 404 may output a variety of tasks that may be performed by the user. As such, these suggested tasks may be performed by the user with the device 100 to generate a variety of training data videos. Accordingly, the suggested task output module 406 may output the suggested tasks to the user. In one example, the suggested tasks may be displayed on the screen 316. In another example, the suggested tasks may be output via the speaker 318. Accordingly, the user may look at the screen 316 and/or listen to the speaker 318 to get ideas for tasks that may be performed.

Referring still to FIG. 4, the video reception module 408 may receive video of tasks task being performed by the user utilizing the device 100. In some examples, the user may perform tasks using one device 100 held in one hand. In other examples, the user may perform tasks using two devices 100, with one device 100 held in each hand. As the user performs a task, the camera 312 on the device or devices 100 may record video of the task being performed, which is received by the video reception module 408. In some examples, the head-mounted camera 500 may also record video of the task being performed, which is received by the video reception module 408. The received videos may be used as training data to train the robot 200 to perform the task being performed in the videos.

Referring still to FIG. 4, the video synchronization module 410 may synchronize the videos received from the device or devices 100 and the head-mounted camera 500. For example, the video synchronization module 410 may synchronize the clocks of the cameras associated with the devices 100 and the head-mounted camera 500 before data collection is started. The video synchronization module 410 may then record a time stamp from each camera when data collection is started. As such, the video from each device may be synchronized such that the training data can include multiple videos of tasks being performed from different perspectives.

Referring still to FIG. 4, the training data storage module 412 may store video of the task being performed by the user as training data. In particular, as discussed above, the device or devices 100 and the head-mounted camera 500 may collect video of the user performing a task with the device or devices 100. The video synchronization module 410 may synchronize the video from each device. Then, the training data storage module 412 may store the synchronized video in the data storage component 308. The stored training data may be used to train the robot 200 to perform tasks via imitation learning.

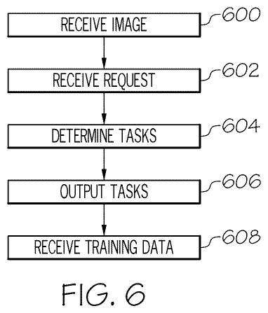

FIG. 6 depicts a flowchart of an example method for operating the computing device 106 for performing task selection for a hand-held manipulation device. At step 600, the image reception module 400 receives an image of a scene. As discussed above, the image may be received from the camera 312 of the device 100 or from the head-mounted camera 500. The captured image may be of a scene for which the user desires to perform tasks.

At step 602, the audio reception module 402 receives a request to identify tasks that may be performed by a user utilizing the device 100 based on the image of the scene. For example, the user may speak a command such as “suggest tasks”, which may be detected by the microphone 314. In other examples, the user may request tasks that may be performed by entering a request into a keyboard associated with the computing device 106 or pressing a button or switch on the handle 101 of the device 100. In other examples, the user may request tasks that may be performed using any other operation associated with the device 100.

At step 604, in response to receiving the request to identify the tasks that may be performed by the user utilizing the device 100, the VLM module 404 analyzes the image of the scene to determine one or more suggested tasks that may be performed by the user utilizing the device 100. In particular, the VLM module 404 may input the image of the scene received by the image reception module 400 into a VLM along with a prompt requesting one or more suggested tasks that may be performed based on the image of the scene. In some examples, the prompt may also specify preferences associated with the tasks to be performed. Once the VLM receives the image and the prompt, the VLM may output one or more tasks that may be performed by the user in the particular scene captured in the image.

At step 606, the suggested task output module 406 outputs the one or more suggested tasks that may be performed by the user utilizing the device 100. In particular, the suggested task output module 406 may output the suggested tasks output by the VLM, as discussed above. In some examples, the suggested task output module 406 may cause the suggested tasks to be displayed on the screen 316. In other examples, the suggested task output module 406 may cause the suggested tasks to be output via audio through the speaker 318.

At step 608, the video reception module 408 receives training data in response to the suggested task output module 406 outputting the one or more suggested tasks that may be performed by the user utilizing the device 100. In particular, after the suggested task output module 406 outputs the suggested tasks, the user may view or listen to the suggested tasks via the screen 316 and/or the speaker 318. The user may then decide on a task to perform with the device or devices 100. The user may then speak the name of the task to be performed and perform the task. As the user performs the task, the camera 312 of the device or devices 100 and/or the head-mounted camera 500 may record video of the task being performed.

After the user finishes performing the task, the video reception module 408 may receive the recorded video or videos. In an example where tasks are performed with a single device 100, the video reception module 408 may receive a video from a first device 100 of each task being performed. In an example where tasks are performed with two devices 100, the video reception module 408 may receive a first video from a first device 100 of each task being performed and a second video from a second device 100 of each task being performed. In an example where the head-mounted camera 500 is used, the video reception module 408 may receive a first video from a first device 100 of each task being performed, a second video from a second device 100 of each task being performed, and a third video from the head-mounted camera 500 of each task being performed.

The video synchronization module 410 may synchronize the videos received by the video reception module 408. In an example where the user performs tasks with two devices 100, the video synchronization module 410 may synchronize a first clock associated with a first device 100 and a second clock associated with a second device 100. In an example where the head-mounted camera 500 is also used, the video synchronization module 410 may synchronize a first clock associated with a first device 100, a second clock associated with a second device 100, and a third clock associated with a head-mounted camera 100.

The training data storage module 412 may then store the received videos as training data in the data storage component 308. In particular, the videos may be stored along with the name of each task being performed in each video, as received by the audio reception module 402. In examples where videos are recorded by two devices 100 and/or the head-mounted camera 500, the training data storage module 412 may store videos from each of the two devices 100 and/or the head-mounted camera 500 as training data. The training data videos may then be used to train the robot 200 to perform the specified task. The user may then perform additional tasks or repeatedly perform the same task, in order to generate additional training data.

It should now be understood that embodiments described herein are directed to task selection for a hand-held manipulation device. By capturing an image of a scene in an environment, and using a VLM to suggest tasks to be performed in the environment, a user may be able to perform a wider variety of tasks, as suggested by the VLM, without having to come up with the ideas of the tasks to be performed on their own. In addition, collecting video of the performance of such tasks using two hand-held devices and a head-mounted camera may increase the amount of training data available to train a robot to perform the task. This may increase the effectiveness of the training of the robot.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving an image of a scene;
receiving a request to identify tasks that may be performed by a user utilizing a hand-held manipulation device, based on the image of the scene;
in response to receiving the request to identify the tasks that may be performed by the user utilizing the hand-held manipulation device, analyzing the image of the scene to determine one or more suggested tasks that may be performed by the user utilizing the hand-held manipulation device;
outputting the one or more suggested tasks that may be performed by the user utilizing the hand-held manipulation device; and
receiving training data in response to outputting the one or more suggested tasks that may be performed by the user utilizing the hand-held manipulation device.

2. The method of claim 1, further comprising:
inputting the image of the scene into a vision language model, and determining the one or more suggested tasks that may be performed by the user utilizing the hand-held manipulation device based on an output of the vision language model.

3. The method of claim 2, further comprising:
training the vision language model to receive the image of the scene as input, and output the one or more suggested tasks that may be performed by the user utilizing the hand-held manipulation device based on the image of the scene.

4. The method of claim 1, further comprising:
receiving preferences associated with the tasks that may be performed by a user utilizing the hand-held manipulation device; and
determining the one or more suggested tasks that may be performed by the user utilizing the hand-held manipulation device based at least in part on the preferences.

5. The method of claim 1, wherein the training data comprises a video of the user utilizing the hand-held manipulation device to perform a task.

6. The method of claim 5, further comprising:
receiving audio indicating the task to be performed; and
storing the video in association with the audio as the training data.

7. The method of claim 1, further comprising:
receiving, from a first hand-held manipulation device, a first video of the first hand-held manipulation device and a second hand-held manipulation device performing a task;
receiving, from the second hand-held manipulation device, a second video of the first hand-held manipulation device and the second hand-held manipulation device performing the task; and
storing the first video and the second video as the training data.

8. The method of claim 1, further comprising:
receiving, from a first hand-held manipulation device, a first video of the first hand-held manipulation device and a second hand-held manipulation device performing a task;
receiving, from the second hand-held manipulation device, a second video of the first hand-held manipulation device and the second hand-held manipulation device performing the task;
receiving, from a head-mounted camera, a third video of the first hand-held manipulation device and the second hand-held manipulation device performing the task; and
storing the first video, the second video, and the third video as the training data.

9. The method of claim 8, further comprising:
synchronizing a first clock of the first hand-held manipulation device, a second clock of the second hand-held manipulation device, and a third clock of the head-mounted camera before the first video, the second video and the third video are recorded.

10. A computing device comprising one or more processors configured to:
receive an image of a scene;
receive a request to identify tasks that may be performed by a user utilizing a hand-held manipulation device, based on the image of the scene;
in response to receiving the request to identify the tasks that may be performed by the user utilizing the hand-held manipulation device, analyze the image of the scene to determine one or more suggested tasks that may be performed by the user utilizing the hand-held manipulation device;
output the one or more suggested tasks that may be performed by the user utilizing the hand-held manipulation device; and
receive training data in response to outputting the one or more suggested tasks that may be performed by the user utilizing the hand-held manipulation device.

11. The computing device of claim 10, wherein the one or more processors are further configured to:
input the image of the scene into a vision language model, and determine the one or more suggested tasks that may be performed by the user utilizing the hand-held manipulation device based on an output of the vision language model.

12. The computing device of claim 11, wherein the one or more processors are further configured to:
train the vision language model to receive the image of the scene as input, and output the one or more suggested tasks that may be performed by the user utilizing the hand-held manipulation device based on the image of the scene.

13. The computing device of claim 10, wherein the one or more processors are further configured to:
receive preferences associated with the tasks that may be performed by a user utilizing the hand-held manipulation device; and
determine the one or more suggested tasks that may be performed by the user utilizing the hand-held manipulation device based at least in part on the preferences.

14. The computing device of claim 10, wherein the training data comprises a video of the user utilizing the hand-held manipulation device to perform a task.

15. The computing device of claim 14, wherein the one or more processors are further configured to:
receive audio indicating the task to be performed; and
store the video in association with the audio as the training data.

16. The computing device of claim 10, wherein the one or more processors are further configured to:
receive, from a first hand-held manipulation device, a first video of the first hand-held manipulation device and a second hand-held manipulation device performing a task;
receive, from the second hand-held manipulation device, a second video of the first hand-held manipulation device and the second hand-held manipulation device performing the task; and
store the first video and the second video as the training data.

17. The computing device of claim 10, wherein the one or more processors are further configured to:
receive, from a first hand-held manipulation device, a first video of the first hand-held manipulation device and a second hand-held manipulation device performing a task;
receive, from the second hand-held manipulation device, a second video of the first hand-held manipulation device and the second hand-held manipulation device performing the task;
receive, from a head-mounted camera, a third video of the first hand-held manipulation device and the second hand-held manipulation device performing the task; and
store the first video, the second video, and the third video as the training data.

18. The computing device of claim 17, wherein the one or more processors are further configured to:
synchronize a first clock of the first hand-held manipulation device, a second clock of the second hand-held manipulation device, and a third clock of the head-mounted camera before the first video, the second video and the third video are recorded.

19. A non-transitory computer readable storage medium comprising a memory storing a program that, when executed by a processor, causes the processor to:
receive an image of a scene;
receive a request to identify tasks that may be performed by a user utilizing a hand-held manipulation device, based on the image of the scene;
in response to receiving the request to identify the tasks that may be performed by the user utilizing the hand-held manipulation device, analyze the image of the scene to determine one or more suggested tasks that may be performed by the user utilizing the hand-held manipulation device;
output the one or more suggested tasks that may be performed by the user utilizing the hand-held manipulation device; and
receive training data in response to outputting the one or more suggested tasks that may be performed by the user utilizing the hand-held manipulation device.

20. The non-transitory computer readable storage medium of claim 19, wherein the program further causes the processor to:
input the image of the scene into a vision language model, and determine the one or more suggested tasks that may be performed by the user utilizing the hand-held manipulation device based on an output of the vision language model.
